(19) United States
(12) Patent Application Publication
(10) Pub. No.: US 2026/0249418 A1
(43) Pub. Date: Aug. 27, 2026

(54) POLISHING APPARATUS

(71) Applicant: EBARA CORPORATION, Tokyo (JP)

(72) Inventors: Toshifumi KIMBA, Tokyo (JP); Masaki KINOSHITA, Tokyo (JP)

(21) Appl. No.: 19/535,999

(22) Filed: Feb. 10, 2026

(30) Foreign Application Priority Data
Feb. 14, 2025 (JP) 2025-022280

(51) Int. Cl. B24B 37/013; B24B 37/005

(52) U.S. Cl. CPC B24B 37/013; B24B 37/0053

(57) ABSTRACT

A polishing apparatus capable of determining a state change of a wafer more accurately and with faster responsiveness is disclosed. The polishing apparatus includes a detection device and a control device. The detection device periodically detects a reference position rotating together with a polishing head. The control device determines a state change of a substrate based on the reference position periodically detected by the detection device.

### CROSS REFERENCE TO RELATED APPLICATION

This document claims priority to Japanese Patent Application No. 2025-022280 filed Feb. 14, 2025, the entire contents of which are hereby incorporated by reference.

### BACKGROUND

Chemical mechanical polishing (CMP) is known as a technique in a manufacturing process of a semiconductor device. A polishing apparatus for performing CMP includes a polishing table that supports a polishing pad, and a polishing head for holding a wafer.

When polishing the wafer using such a polishing apparatus, the wafer is brought into sliding contact with a polishing surface by relatively moving the polishing table and the polishing head, thereby polishing a surface to be polished of the wafer.

Generally, a state change (e.g., polishing end point) of the wafer is determined or a polishing state of the wafer is monitored based on a film thickness distribution of the wafer. However, methods for monitoring (determining) the state of the wafer held by the polishing head in real time are limited.

For example, a method is known in which a state change of the wafer is determined based on a motor torque of a polishing table that changes together with a change in frictional force between the wafer and a polishing pad. However, such a method is a method of indirectly monitoring the state change of the wafer based on a motor current supplied to the polishing table. A method for determining the state change of the wafer more accurately and with faster responsiveness is desired.

### SUMMARY

Therefore, a polishing apparatus capable of determining a state change of a wafer more accurately and with faster responsiveness is provided.

Embodiments described below relate to a polishing apparatus.

In an embodiment, there is provided a polishing apparatus comprising: a polishing table configured to support a polishing pad; a polishing head configured to hold a substrate with an exposed surface of the substrate facing a polishing surface of the polishing pad; a detection device configured to detect a reference position of the substrate; and a control device electrically connected to the detection device, the detection device is configured to periodically detect the reference position rotating together with the polishing head, and the control device is configured to determine a state change of the substrate based on the reference position periodically detected by the detection device.

In an embodiment, the reference position corresponds to a notch position formed at a peripheral edge of the substrate, the detection device is configured to: project light from outside the substrate toward the peripheral edge of the substrate, and detect reflected light reflected at the peripheral edge of the substrate, and the control device is configured to determine the notch position based on an intensity of the reflected light detected by the detection device.

In an embodiment, the substrate has a structure including a plurality of materials having different friction coefficients, and the control device is configured to determine a polishing end point as the state change based on a change in a friction coefficient between the substrate and the polishing pad caused by a surface structure of the substrate that changes with progress of polishing.

In an embodiment, the control device is configured to measure a phase of the reference position, and determine a polishing abnormality of the substrate based on a magnitude of a change in the phase when the state change is determined.

In an embodiment, when constituent elements of the polishing apparatus including at least the polishing pad, the polishing table, and the polishing head are defined as polishing components, the control device is configured to determine an occurrence of at least one of an abnormality of the substrate itself and an abnormality of the polishing components as the polishing abnormality.

In an embodiment, the control device is configured to determine a change in polishing conditions of the substrate as the state change based on a change in a friction coefficient between the substrate and the polishing pad.

In an embodiment, the polishing apparatus comprises a film thickness sensor embedded in the polishing table, the film thickness sensor is configured to periodically detect a signal reflecting a film thickness of the substrate along with rotation of the polishing table, and the control device is configured to: measure the film thickness of the substrate based on the signal detected by the film thickness sensor; specify a substrate angle as an angle in a circumferential direction of the substrate specified by the reference position based on a phase of the reference position detected by the detection device and a phase of the signal detected by the film thickness sensor; and create film thickness distribution information of the substrate based on the specified substrate angle and the measured film thickness of the substrate.

In an embodiment, the control device is configured to: calculate a rotation time of the substrate per unit angle from a time interval of the reference position detected by the detection device; and specify the substrate angle based on the rotation time of the substrate and a time interval from a time point when the detection device detects the reference position to a time point when the film thickness sensor detects the signal.

According to the above-described means, the polishing apparatus can determine the state change of the substrate more accurately and with faster responsiveness.

### BRIEF DESCRIPTION OF THE DRAWINGS

FIG. 1 is a schematic view showing an embodiment of a polishing apparatus;

FIG. 2 is a cross-sectional view of a polishing head;

FIG. 3 is a schematic view showing an elastic membrane connected to a lower surface of a head main body;

FIG. 4A, FIG. 4B, and FIG. 4C are views showing examples of a film thickness distribution along a circumferential direction of a wafer at a peripheral edge of the wafer;

FIG. 5 is a view showing a positional relationship between the wafer and a polishing pad;

FIG. 6 is a view showing a polishing head disassembled into constituent elements;

FIG. 7A is a view showing a detection device;

FIG. 7B is a view showing the detection device;

FIG. 7C is a view showing the detection device;

FIG. 7D is a view showing the detection device;

FIG. 7E is a view showing the detection device;

FIG. 8 is a view showing a light guide structure constituting the detection device;

FIG. 9 is a view showing a detection unit constituting the detection device;

FIG. 10 is a view showing movement of the wafer surrounded by a retainer ring during polishing of the wafer;

FIG. 11A is a view showing the presence or absence of detection of reflected light at a peripheral edge of the wafer by a photodetector;

FIG. 11B is a view showing the presence or absence of detection of reflected light at a peripheral edge of the wafer by a photodetector;

FIG. 11C is a view visualizing a notch position detected by a photodetector;

FIG. 12 is a timing chart showing notch positions periodically detected by a photodetector;

FIG. 13 is a view showing a processing flow of a control device for determining a state change of the wafer;

FIG. 14 is a cross-sectional view showing another embodiment of a light guide structure;

FIG. 15 is a view showing light passing through a cell structure;

FIG. 16A is a view showing a plurality of cell structures arranged side by side in an annular shape;

FIG. 16B is a view showing a plurality of cell structures arranged in a plurality of rows in a height direction of a polishing head;

FIG. 17 is a view showing another embodiment of the light guide structure;

FIG. 18 is a view of a glass body viewed from above;

FIG. 19 is a view showing a change in a contact point position;

FIG. 20A is a view showing another embodiment of the detection unit;

FIG. 20B is a view showing another embodiment of the detection unit;

FIG. 21A is a view showing another embodiment of the detection unit;

FIG. 21B is a view showing another embodiment of the detection unit;

FIG. 22 is a view showing an embodiment of a film thickness sensor;

FIG. 23 is a timing chart showing a phase of the notch position detected by the detection device and a phase of a signal detected by the film thickness sensor;

FIG. 24 is a view showing a processing flow of the control device for specifying the notch angle;

FIG. 25 is a view showing an attachment angle of a detection unit; and

FIG. 26 is a view showing a processing flow of the control device when polishing the wafer.

### DESCRIPTION OF EMBODIMENTS

Hereinafter, embodiments will be described with reference to the drawings. In the drawings described below, the same or corresponding constituent elements are denoted by the same reference numerals, and redundant description thereof will be omitted. In a plurality of embodiments described below, a configuration of one embodiment that is not particularly described is the same as that of other embodiments, and therefore redundant description thereof will be omitted.

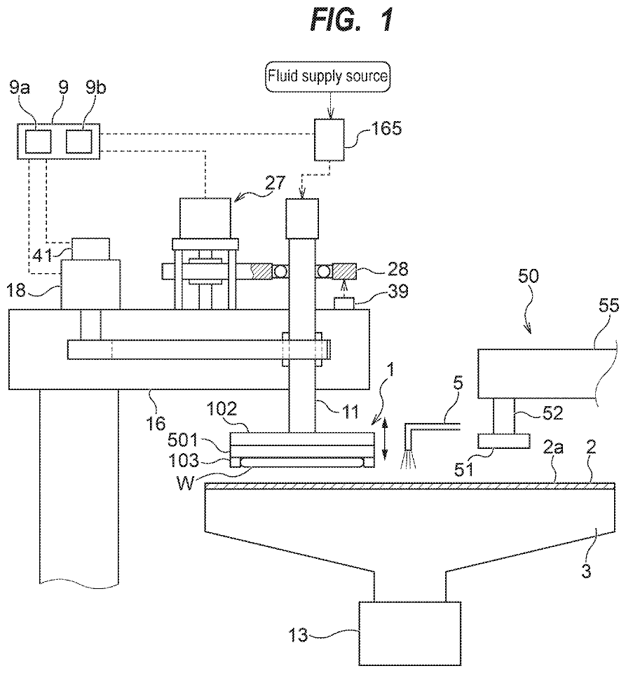

FIG. 1 is a schematic view showing an embodiment of a polishing apparatus. As shown in FIG. 1, the polishing apparatus includes a polishing head (substrate holding apparatus) 1 that holds and rotates a wafer W, which is an example of a substrate, a polishing table 3 that supports a polishing pad 2, a polishing liquid supply nozzle 5 that supplies a polishing liquid (slurry) to the polishing pad 2, and a control device 9 that controls operations of these constituent elements of the polishing apparatus.

The polishing head 1 causes an exposed surface (that is, a surface to be polished) of the wafer W to face a polishing surface 2a of the polishing pad 2. The polishing head 1 and the polishing table 3 rotate in the same direction, and in this state, the polishing head 1 presses the wafer W against the polishing surface 2a.

The polishing table 3 is connected to a table motor 13 and is configured to be rotatable. The polishing pad 2 is attached to an upper surface of the polishing table 3. The polishing head 1 is connected to a polishing head shaft 11. The polishing head shaft 11 is configured to move up and down relative to a head arm 16 by an up-down movement mechanism 27.

The control device 9 is composed of at least one computer. The control device 9 includes a storage device 9a in which programs are stored, and a processing device 9b that executes calculations according to instructions included in the programs. The processing device 9b includes a CPU (central processing unit) or a GPU (graphics processing unit) that performs calculations according to instructions included in the programs stored in the storage device 9a.

The polishing apparatus includes a polishing head height sensor 39 facing a bridge 28. The polishing head height sensor 39 is electrically connected to the control device 9. The control device 9 measures the height of the polishing head 1 based on a signal sent from the polishing head height sensor 39.

The polishing head 1 holding the wafer W is moved from a transfer position of the wafer W to a position above the polishing table 3 by pivoting the head arm 16. The polishing head 1 and the polishing table 3 are respectively rotated, and the polishing liquid is supplied onto the polishing pad 2 from the polishing liquid supply nozzle 5 arranged above the polishing table 3.

The polishing head 1 presses the wafer W against the polishing surface 2a of the polishing pad 2, and brings the wafer W into sliding contact with the polishing surface 2a of the polishing pad 2 in the presence of the polishing liquid. The surface of the wafer W is polished by a chemical action by chemical components of the polishing liquid and a mechanical action of abrasive grains contained in the polishing liquid.

In the embodiment shown in FIG. 1, the polishing apparatus is a face-down type polishing apparatus. In one embodiment, the polishing apparatus may be a face-up type polishing apparatus. In this case, although not shown, the polishing head 1 holds the wafer W such that the surface to be polished of the wafer W faces upward, and a polishing tool holding the polishing pad 2 is pressed against the surface to be polished of the wafer W.

As shown in FIG. 1, the polishing apparatus includes a dressing unit 50 that dresses the polishing surface 2a of the polishing pad 2. The dressing unit 50 includes a dresser 51 that is brought into sliding contact with the polishing surface 2a, a dresser shaft 52 to which the dresser 51 is connected, and a swing arm 55 that rotatably supports the dresser shaft 52.

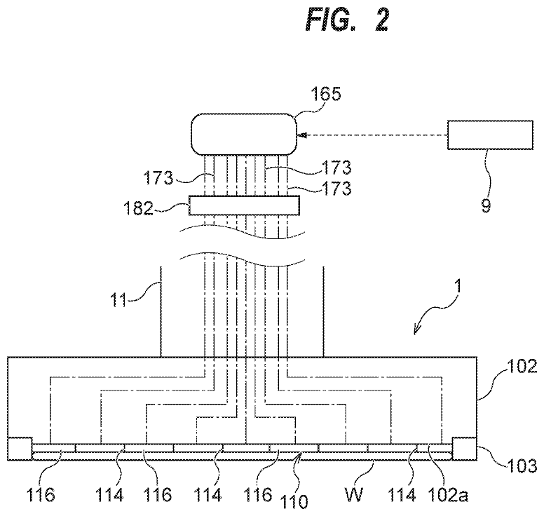

FIG. 2 is a cross-sectional view of the polishing head. As shown in FIG. 2, the polishing head 1 includes a head main body 102 connected to the polishing head shaft 11, and a retainer ring 103 arranged to surround the wafer W. The retainer ring 103 is configured to be movable up and down independently of the head main body 102.

The polishing head 1 has a plurality of pressing elements for pressing the wafer W against the polishing surface 2a of the polishing pad 2. Examples of the pressing elements include a pressurizing mechanism provided in the polishing head 1, or a piezoelectric element provided in the polishing head 1. In this embodiment, the pressing element is a pressurizing mechanism provided in the polishing head 1.

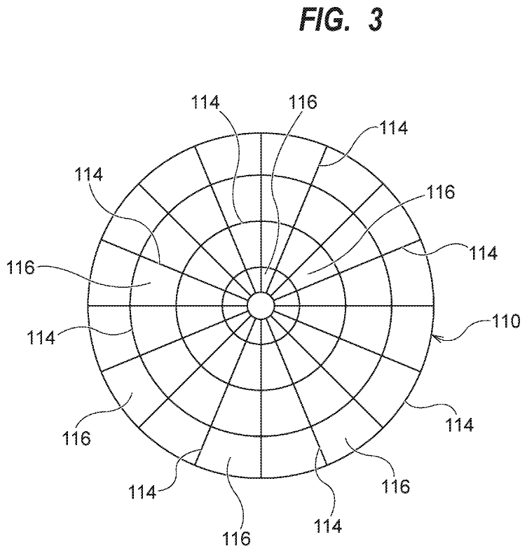

FIG. 3 is a schematic view showing an elastic membrane connected to a lower surface of the head main body. As shown in FIGS. 2 and 3, the polishing head 1 includes an elastic membrane 110 connected to a lower surface 102a of the head main body 102.

The elastic membrane 110 that comes into contact with a back surface of the wafer W includes a plurality of walls 114. In the embodiment shown in FIG. 3, the plurality of walls 114 are arranged along a radial direction and a circumferential direction of the polishing head 1. The retainer ring 103 is arranged to surround the elastic membrane 110.

The plurality of walls 114 form a plurality of pressure chambers 116 arranged along the radial direction and the circumferential direction of the polishing head 1. The pressurizing mechanism as the pressing element has the pressure chambers 116 formed in the elastic membrane 110. A fluid supply source (see FIG. 1) supplies fluid to the pressure chambers 116 to pressurize the pressure chambers 116.

The polishing apparatus includes a pressure adjustment device (that is, a pressure regulator) 165 capable of individually controlling pressing forces of the plurality of pressing elements. The pressure adjustment device 165 is configured to individually adjust pressures in the pressure chambers 116.

Each pressure chamber 116 is connected to the pressure adjustment device 165 via a rotary joint 182, and the fluid from the fluid supply source is supplied to each pressure chamber 116 through a fluid line 173. The pressure adjustment device 165 is electrically connected to the control device 9, and the control device 9 is configured to independently adjust the pressure in each pressure chamber 116.

The pressure adjustment device 165 can also form a negative pressure in the pressure chambers 116. Each pressure chamber 116 is also connected to an atmosphere opening mechanism (not shown), and the pressure chambers 116 can also be opened to the atmosphere.

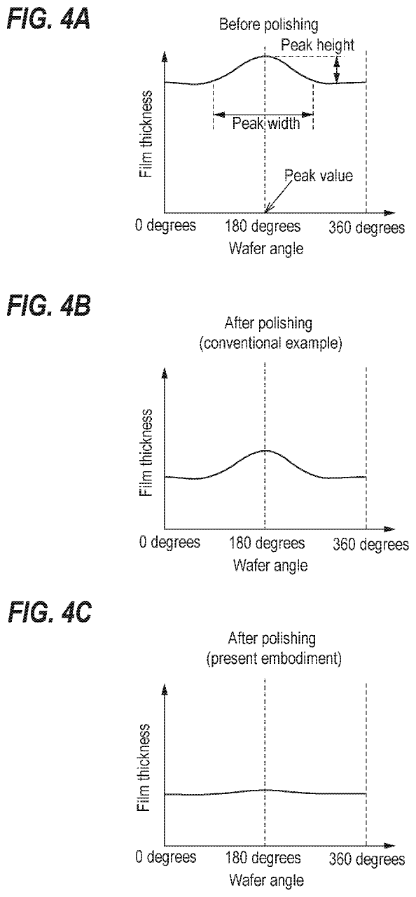

FIG. 4A, FIG. 4B, and FIG. 4C are views showing examples of a film thickness distribution along a circumferential direction of the wafer at a peripheral edge of the wafer. FIG. 4A shows an initial film thickness distribution before wafer polishing. FIG. 4B shows a film thickness distribution of the wafer when polished by a conventional polishing apparatus. FIG. 4C exemplarily shows a film thickness distribution of the wafer when polished by the polishing apparatus of the present embodiment.

A position at a wafer angle (that is, substrate angle) of 0 degrees in FIGS. 4A to 4C is set to a position of a characteristic portion that can specify the angle (or orientation) in the circumferential direction of the wafer. In the examples shown in FIGS. 4A to 4C, the position at the wafer angle of 0 degrees is a notch position (that is, a reference position) formed at the peripheral edge of the wafer.

In FIG. 4A, the initial film thickness distribution before polishing shows a peak position at a wafer angle of 180 degrees, indicating variations in film thickness having a certain peak width and peak height. Possible causes of such an initial film thickness distribution include characteristics of a film forming apparatus and effects of various processes for forming multilayer wiring.

When the wafer having the initial film thickness distribution of FIG. 4A is polished using a conventional polishing apparatus, polishing proceeds substantially uniformly in the circumferential direction, so that a film thickness distribution substantially the same as that before polishing remains on the polished wafer (see FIG. 4B). Such variations in film thickness distribution can cause a failure to focus in the next exposure step, thereby reducing the yield of semiconductor manufacturing.

In FIG. 4C, when the polishing apparatus of the present embodiment polishes the wafer having the initial film thickness distribution of FIG. 4A, the polishing apparatus makes a polishing rate at the peak position relatively high (or low), thereby being able to reduce the film thickness variation in the circumferential direction compared to the initial film thickness distribution.

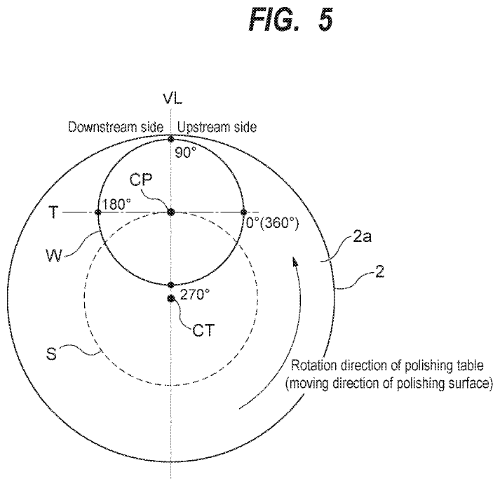

FIG. 5 is a view showing a positional relationship between the wafer and a polishing pad. A line segment passing through the center CT of the polishing surface 2a and extending parallel to the polishing pad 2 is defined as an imaginary line VL. When the center CP of the wafer W is placed on the imaginary line VL, the polishing surface 2a can be divided into an upstream side of the imaginary line VL and a downstream side of the imaginary line VL with respect to its rotation direction. The upstream side of the imaginary line VL and the downstream side of the imaginary line VL are, in other words, an upstream side and a downstream side of the wafer W with respect to a moving direction of the polishing surface 2a.

A virtual circle S shown in FIG. 5 is a rotation trajectory of the polishing surface 2a passing through the center CP of the wafer W. Among two intersections of a tangent T of the virtual circle S at the wafer center CP and a wafer circle, an upstream intersection is defined as a polishing head angle of 0 degrees, and a downstream intersection is defined as a polishing head angle of 180 degrees. Among two intersections of the imaginary line VL and the wafer circle, an intersection on the polishing surface center side is defined as a polishing head angle of 270 degrees, and an intersection on a polishing surface outer periphery side is defined as a polishing head angle of 90 degrees. Here, the wafer circle is a circle representing an outline of the wafer W.

The polishing head angle is an initial rotation angle at the position of the polishing head 1 when starting to polish the wafer W. The rotation angle of the polishing head 1 is detected by a rotary encoder 41 (see FIG. 1) attached to a polishing head motor 18. The rotary encoder 41 is a rotation angle detector that detects the rotation angle of the polishing head 1.

In order to improve the uniformity of film thickness distribution, it is important to acquire (create) accurate film thickness distribution information (wafer map) during polishing of the wafer W. Furthermore, in order to acquire accurate film thickness distribution information, it is important to accurately specify a reference position of the wafer angle (that is, the notch position). The film thickness distribution information is information associating coordinate positions of the wafer W centered on the reference position of the wafer W with film thicknesses of the wafer W in a radial direction and a circumferential direction of the wafer W.

In order to determine a state change of the wafer W (e.g., polishing end point, polishing abnormality, change in polishing conditions), it is important to monitor a polishing state of the wafer W. In order to accurately monitor the polishing state of the wafer W, it is important to accurately specify the reference position of the wafer angle.

Therefore, in order to achieve the object of acquiring accurate film thickness distribution information or the object of determining a state change of the wafer W, the polishing apparatus has a configuration that accurately specifies a reference position. Such a configuration will be described below.

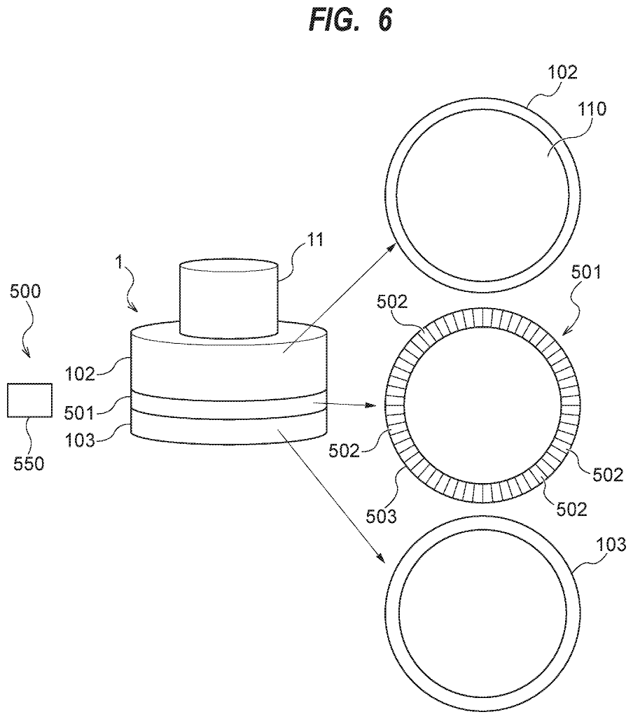

FIG. 6 is a view showing a polishing head disassembled into constituent elements. As shown in FIG. 6, when the polishing head 1 is disassembled, a detection device 500 for detecting the notch position as a reference position is arranged between the head main body 102 and the retainer ring 103.

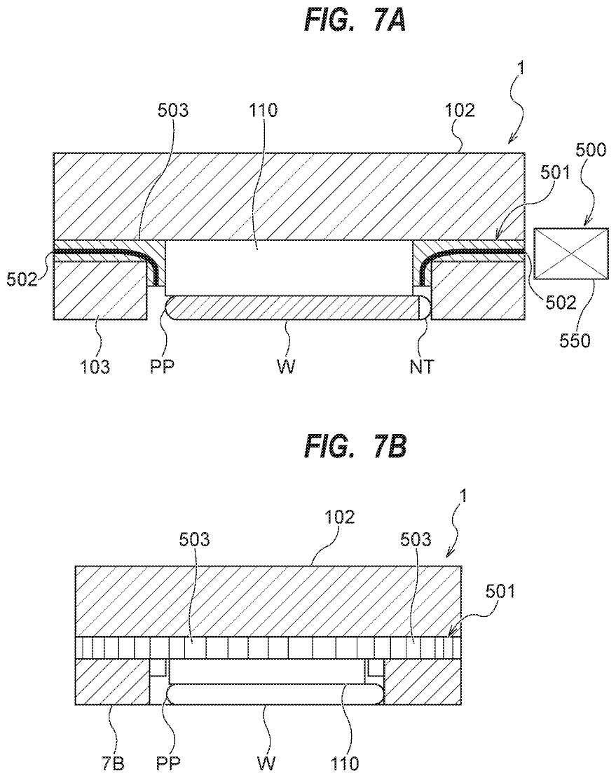

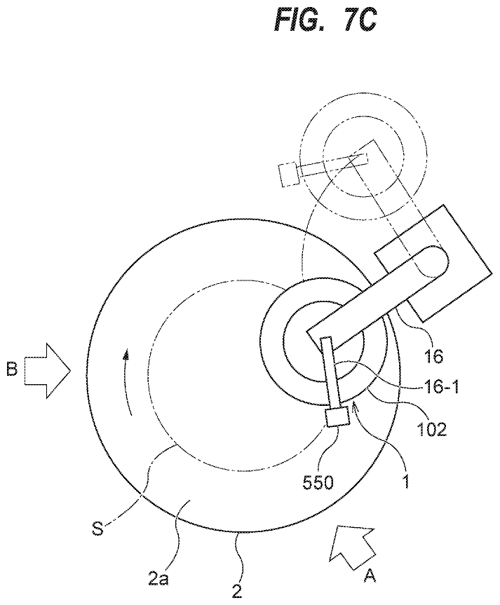

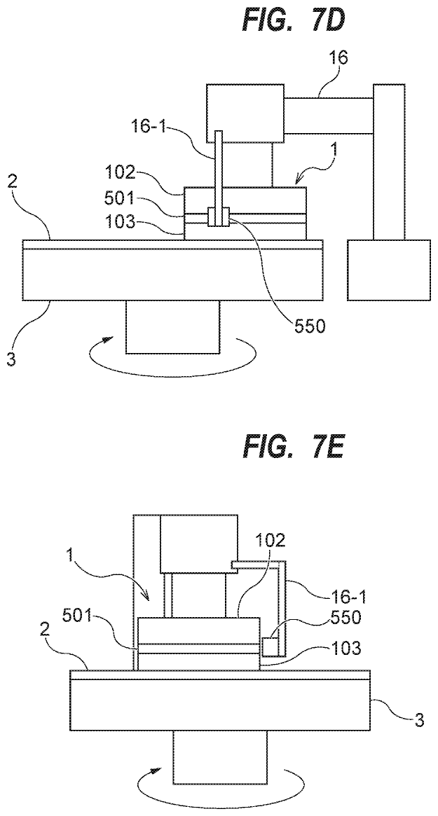

FIGS. 7A to 7E are views showing the detection device. FIG. 8 is a view showing a light guide structure constituting the detection device. FIG. 9 is a view showing a detection unit constituting the detection device. The detection device 500 is configured to project light from outside the wafer W toward a peripheral edge PP of the wafer W, and detect reflected light reflected at the peripheral edge PP of the wafer W.

The detection device 500 includes a light guide structure 501 arranged adjacent to the peripheral edge PP of the wafer W, and a detection unit 550 that guides light to the peripheral edge PP of the wafer W through the light guide structure 501 and detects the notch position NT from reflected light reflected at the peripheral edge PP of the wafer W.

In the embodiment shown in FIG. 6, the light guide structure 501 has an annular shape along a circumferential direction of the wafer W, but in one embodiment, the light guide structure 501 may have an arc shape along the circumferential direction of the wafer W. The light guide structure 501 is not necessarily arranged adjacent to the entire peripheral edge PP of the wafer W, and may be arranged adjacent to a part of the peripheral edge PP.

The light guide structure 501 includes a plurality of optical fibers 502 arranged along the circumferential direction of the wafer W, and a fiber holder 503 that holds the plurality of optical fibers 502. The optical fibers 502 are preferably arranged at equal intervals. The fiber holder 503 shown in FIG. 8 has an L-shape.

Specifically, the fiber holder 503 has a main body portion 503a sandwiched between the head main body 102 and the retainer ring 103, and a bent portion 503b bent from the main body portion 503a. When the polishing head 1 holds the wafer W, the bent portion 503b extends downward from the main body portion 503a toward the peripheral edge PP of the wafer W (see FIGS. 7A and 8).

FIG. 7C shows a positional relationship between the detection unit and the polishing head when the polishing apparatus is viewed from above. FIG. 7D shows the polishing apparatus as viewed from a direction of line A in FIG. 7C. FIG. 7E shows the polishing apparatus as viewed from a direction of line B in FIG. 7C.

As shown in FIGS. 7C to 7E, the detection unit 550 is supported by a unit supporter 16-1 extending from the head arm 16. The detection unit 550 is arranged radially outside the light guide structure 501 and outside the polishing head 1. The detection unit 550 is arranged downstream of the polishing head 1 in a rotation direction of the polishing table 3. Note that the detection unit 550 is not necessarily arranged at a position shown in FIGS. 7C to 7E.

As shown in FIG. 9, the detection unit 550 includes a light source 551 that emits light, a half mirror 552 for guiding light emitted from the light source 551 to the light guide structure 501, and the photodetector 553 for detecting reflected light reflected at the peripheral edge PP of the wafer W.

The light emitted from the light source 551 is reflected by the half mirror 552 and enters from a fiber end 502a of the optical fiber 502. The fiber end 502a is an end portion of the optical fiber 502 adjacent to the detection unit 550. The light entering from the fiber end 502a irradiates the peripheral edge PP of the wafer W from a fiber end 502b. The fiber end 502b is an end portion of the optical fiber 502 adjacent to the peripheral edge PP of the wafer W.

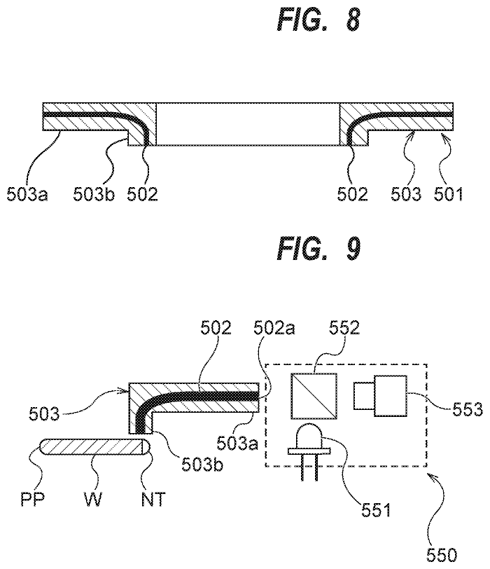

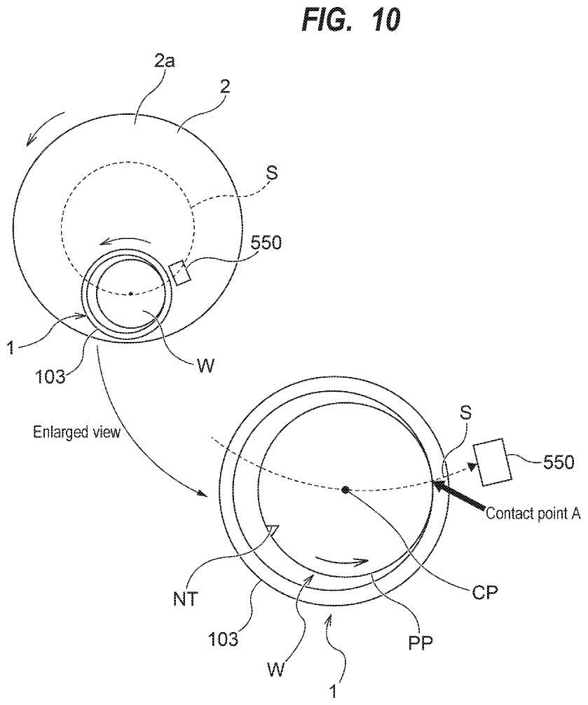

FIG. 10 is a view showing movement of the wafer surrounded by a retainer ring during polishing of the wafer. As shown in FIG. 10, when the polishing table 3 and the polishing head 1 are rotated in the same direction, the wafer W contacts an inner peripheral surface of the retainer ring 103 (see contact point A). The contact point A is located on a rotation trajectory of the polishing surface 2a passing through the center CP of the wafer W (that is, the virtual circle S).

During polishing of the wafer W, the wafer W inside the retainer ring 103 rotates around the contact point A. Therefore, the detection unit 550 is arranged in an area adjacent to the retainer ring 103 and having a certain width (including the contact point A), and light is continuously irradiated from the light source 551 toward the peripheral edge PP of the rotating wafer W.

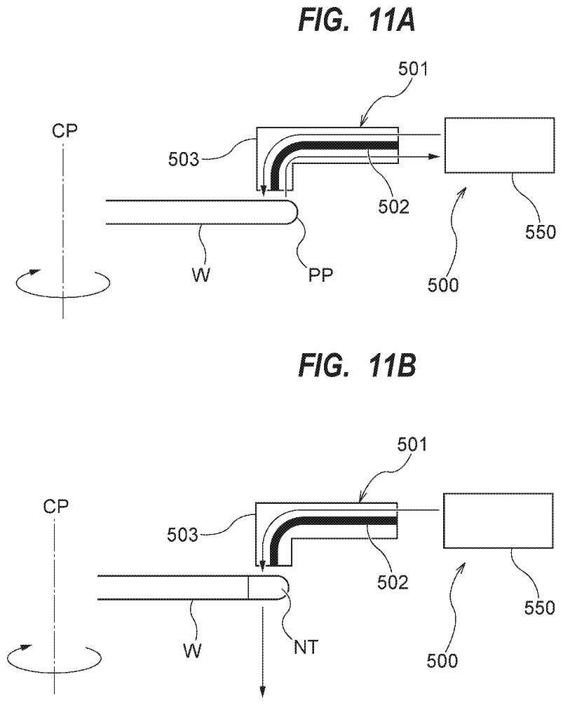

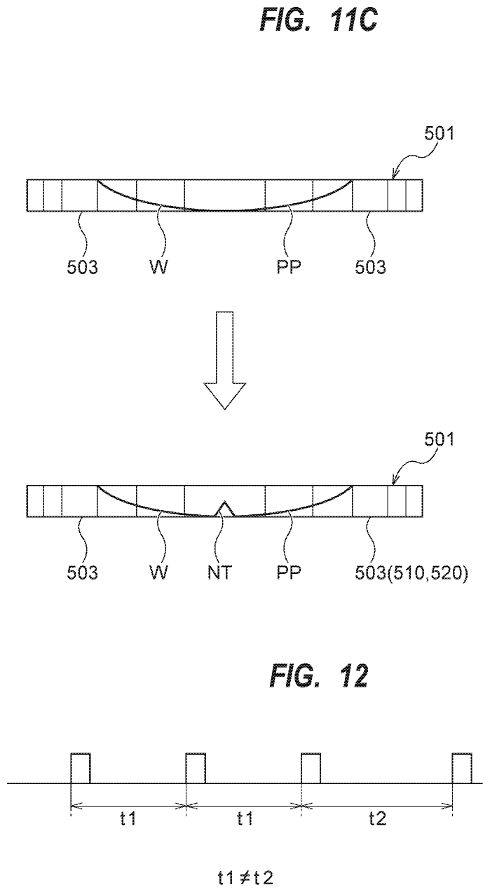

FIG. 11A and FIG. 11B are views showing the presence or absence of detection of reflected light at a peripheral edge of the wafer by a photodetector. As shown in FIG. 11A, when light is irradiated to the peripheral edge PP of the wafer W other than the notch position NT, the light is reflected at the peripheral edge PP of the wafer W, and reflected light enters the fiber end 502b. The entered reflected light is detected by the photodetector 553 through the fiber end 502a and the half mirror 552.

By continuously irradiating light, the light is irradiated to the notch position NT formed at the peripheral edge PP of the rotating wafer W. In this case, as shown in FIG. 11B, the irradiated light passes through the wafer W through the notch position NT, and thus is not reflected at the peripheral edge PP of the wafer W. Alternatively, the irradiated light is reflected with a different intensity from the reflected light at the peripheral edge PP other than the notch position NT, depending on irradiation conditions and a shape of the notch position NT (for example, diffuse reflection due to corners of a notch (cutout) portion, etc.).

FIG. 11C is a view visualizing the notch position detected by a photodetector. The photodetector 553 is configured to detect different light intensities between the notch position NT and the peripheral edge PP other than the notch position NT. When the wafer W rotates at a constant speed around the contact point A, the photodetector 553 detects reflected light having a constant intensity (that is, first reflected light) for a certain long time, and detects reflected light having an intensity different from that of the first reflected light (that is, second reflected light) or cuts off detection of the first reflected light for a certain short time.

The intensity of the first reflected light is largest at a position where the peripheral edge PP of the wafer W is closest to the retainer ring 103, and the intensity of the first reflected light gradually decreases as the wafer W moves away from the retainer ring 103. Further, the photodetector 553 detects the second reflected light or cuts off detection of the first reflected light at the notch position NT. Therefore, as shown in FIG. 11C, the photodetector 553 detects reflected light corresponding to an outline of the wafer W.

The timing at which the photodetector 553 detects the second reflected light or cuts off detection of the first reflected light corresponds to the timing at which the notch position NT passes the photodetector 553. Hereinafter, the timing at which the notch position NT passes the photodetector 553 may be referred to as notch timing.

FIG. 12 is a timing chart showing notch positions periodically detected by a photodetector. A relationship between a rotation speed of the polishing head 1 and a rotation speed of the wafer W is usually constant unless polishing conditions of the wafer W change. Therefore, under conditions where the rotation speed of the wafer W is constant, the notch timing arrives at a constant cycle, at which time the photodetector 553 periodically detects the notch position NT at constant time intervals.

Note that FIG. 12 expresses the first reflected light detected by the photodetector 553 with a non-peak, and expresses the second reflected light detected by the photodetector 553 (or a cutoff of detection of the first reflected light) with a peak.

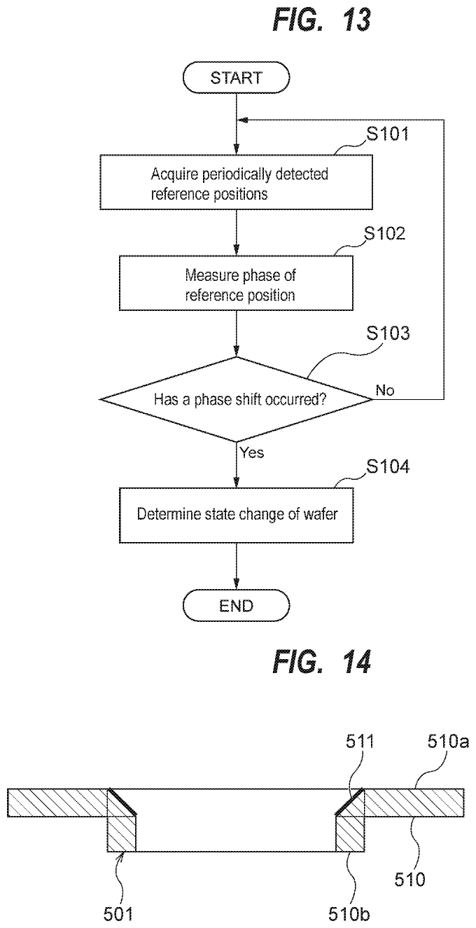

FIG. 13 is a view showing a processing flow of the control device for determining a state change of the wafer. The photodetector 553 is electrically connected to the control device 9. The control device 9 is configured to determine the notch position NT based on an intensity of reflected light detected by the photodetector 553.

First, the control device 9 acquires notch positions NT periodically detected by the photodetector 553 (see step S101), and measures a phase of a reference position based on the acquired notch positions NT (see step S102). In FIG. 12, the control device 9 measures the notch position NT at a constant time interval (see t1).

Thereafter, the control device 9 determines whether a shift (change) has occurred in the measured phase (see step S103), and when determining that no phase shift has occurred (see “No” in step S103), repeats step S101 and step S102.

When determining that a phase shift has occurred (see “Yes” in step S103), the control device 9 determines a state change of the wafer W (see step S104). In FIG. 12, the control device 9 measures the notch position NT at a second time interval (t2) different from a first time interval (t1) (t1≠t2).

The control device 9 determines a state change of the wafer W based on a change in a rotation speed of the wafer W. The wafer W may have a structure including a plurality of materials having different friction coefficients. For example, the wafer W may have an upper layer and a lower layer having different friction coefficients, or may have materials (e.g., wiring layers, etc.) having different friction coefficients within the same plane.

When a surface structure of the wafer W changes with progress of polishing of the wafer W, a friction coefficient between a surface to be polished of the wafer W and the polishing surface 2a of the polishing pad 2 changes. When the friction coefficient changes, a rotation speed of the wafer W also changes, and as a result, a phase of the notch position NT also changes. The control device 9 determines a state change of the wafer W, for example, a polishing end point, by measuring such a phase shift of the notch position NT.

When a magnitude of the phase shift depends on a structure of the wafer W, the control device 9 can determine a polishing end point of the wafer W based on the magnitude of the phase shift determined by the structure of the wafer W. Consequently, the control device 9 can determine a polishing abnormality of the wafer W based on a magnitude of a phase shift when a state change of the wafer W is determined. Specifically, when the control device 9 measures a phase shift having a magnitude different from a magnitude of a phase shift corresponding to a polishing end point of the wafer W, the control device 9 may determine a polishing abnormality of the wafer W.

Constituent elements necessary for polishing the wafer W including at least the polishing pad 2, the polishing table 3, and the polishing head 1 are defined as polishing components. A polishing abnormality of the wafer W is an abnormality of the wafer W itself such as a breakage of the wafer W, or an abnormality of polishing components. The control device 9 determines an occurrence of at least one of an abnormality of the wafer W and an abnormality of polishing components as a polishing abnormality of the wafer W.

Examples of abnormalities of polishing components can include breakages of the polishing pad 2, the elastic membrane 110, and the retainer ring 103. Other examples of abnormalities of polishing components can include failures of the table motor 13 and the polishing head motor 18, and breakages of structures such as bearings.

When polishing conditions of the wafer W change, a state change of the wafer W may occur. For example, a state change of the wafer W may occur due to changes in a material of a polishing liquid, a flow rate of the polishing liquid, a pressure of fluid supplied to the elastic membrane 110, and a surface state of the polishing pad 2. Therefore, the control device 9 may determine a change in polishing conditions of the wafer W as a cause of such a state change of the wafer W.

According to the present embodiment, the detection device 500 can detect the notch position NT of the wafer W surrounded by the retainer ring 103 more accurately and with faster responsiveness from outside the polishing head 1 during polishing of the wafer W. Further, the control device 9 can more accurately determine a state change of the wafer W based on a phase of the notch position NT detected by the detection device 500. Through such a method, the control device 9 can directly monitor a state change of the wafer W without adopting indirect methods such as a method based on a change in a motor current of the polishing table 3.

Although not shown, the polishing apparatus may have a configuration shown in Japanese Laid-Open Patent Publication No. 2021-160025 (that is, a reference position detection device that detects a reference position (notch position) arranged inside the retainer ring 103 during polishing of the wafer W) or a configuration shown in Japanese Laid-Open Patent Publication No. 2022-108789 (a configuration that specifies a reference position of a substrate angle based on signals acquired from a plurality of film thickness sensors). It is also possible to specify the notch position NT by such configurations, and the control device 9 may determine a state change of the wafer W based on a phase of the notch position NT measured based on the above configurations.

FIG. 14 is a cross-sectional view showing another embodiment of the light guide structure. In an embodiment shown in FIG. 14, the light guide structure 501 does not include the optical fiber 502, and instead includes a cell structure 510 of a reflection optical system that allows light to pass and reflects light. The cell structure 510 has an L-shape, and includes a main body portion 510a, a bent portion 510b, and a reflection member 511 arranged at a connection portion between the main body portion 510a and the bent portion 510b. Examples of the reflection member 511 can include a mirror and a prism.

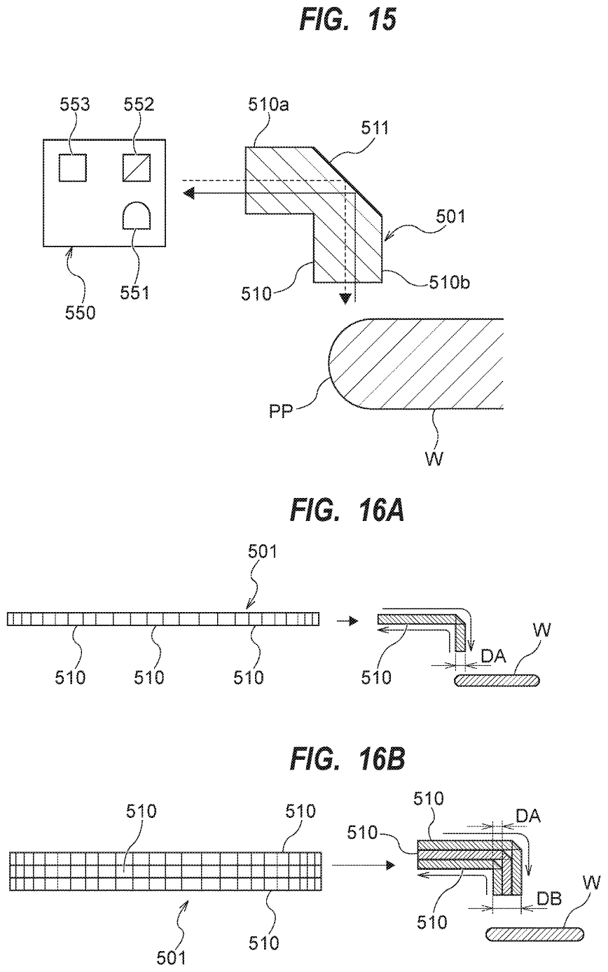

FIG. 15 is a view showing light passing through the cell structure. As shown in FIG. 15, light emitted from the light source 551 enters the cell structure 510, is bent at right angles by the reflection member 511, and irradiates a peripheral edge PP of the wafer W. Light reflected at a peripheral edge PP of the wafer W enters the cell structure 510, is bent at right angles by the reflection member 511, and is detected by the photodetector 553.

FIG. 16A is a view showing a plurality of cell structures arranged side by side in an annular shape. As shown in FIG. 16A, the light guide structure 501 includes a plurality of cell structures 510 arranged side by side in an annular shape. The cell structures 510 adjacent to each other are light-shielded. Therefore, light having passed through the cell structure 510 does not enter adjacent cell structures 510.

In an embodiment shown in FIG. 16A, a plurality of cell structures 510 are arranged in one row in a height direction of the polishing head 1 (that is, an extending direction of the polishing head shaft 11). Therefore, a width of light irradiating a peripheral edge PP of the wafer W corresponds to a thickness of the bent portion 510b of the light guide structure 501. A thickness of the bent portion 510b corresponds to a distance DA in a radial direction of the wafer W. The photodetector 553 detects reflected light corresponding to the distance DA.

FIG. 16B is a view showing a plurality of cell structures arranged in a plurality of rows in a height direction of a polishing head. In an embodiment shown in FIG. 16B, a plurality of cell structures 510 are arranged in a plurality of rows (e.g., three rows) in a height direction of the polishing head 1. Therefore, a width of light entering a peripheral edge PP of the wafer W corresponds to a total thickness of a plurality of bent portions 510b. In FIG. 16B, since the cell structures 510 in three rows are arranged, the photodetector 553 detects reflected light corresponding to a distance DB. The distance DB corresponds to three times the distance DA.

In an embodiment shown in FIG. 16B, the photodetector 553 can detect reflected light in a wider range in a radial direction of the wafer W. Also in embodiments shown in FIGS. 11A to 11C, the light guide structure 501 may include a plurality of optical fibers 502 and fiber holders 503 arranged in a plurality of rows in a height direction of the polishing head 1.

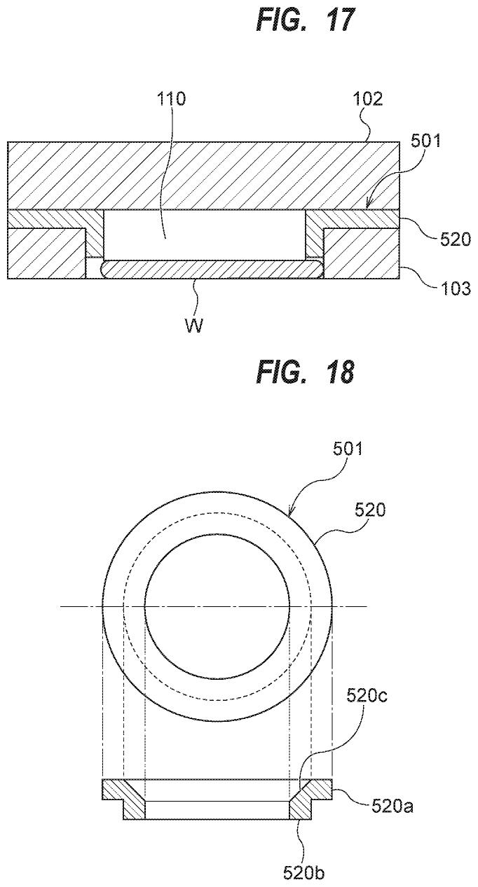

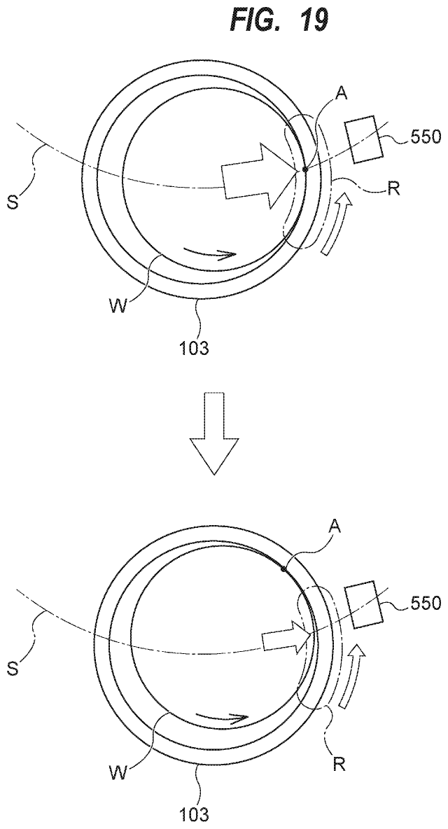

FIG. 17 is a view showing another embodiment of the light guide structure. As shown in FIG. 17, the light guide structure 501 may include a glass body 520. FIG. 18 is a view of a glass body viewed from above. As shown in FIG. 18, the glass body 520 having an annular shape has an L-shaped cross section, and has a main body portion 520a, a bent portion 520b, and a reflection surface 520c formed at a connection portion between the main body portion 520a and a bent portion 520b.

The glass body 520 has basically the same configuration as the cell structure 510. Specifically, the glass body 520 corresponds to an integrally molded member of a plurality of cell structures 510 arranged side by side in an annular shape.

FIG. 19 is a view showing a change in a contact point position. As described above, during polishing of the wafer W, the wafer W inside the retainer ring 103 rotates around a contact point A, but when a friction coefficient between a surface to be polished of the wafer W and the polishing surface 2a of a polishing pad 2 changes, a position of a contact point A may change (see FIG. 19). Therefore, the control device 9 may determine a state change of the wafer W based on a change in a contact point position between the wafer W and the retainer ring 103.

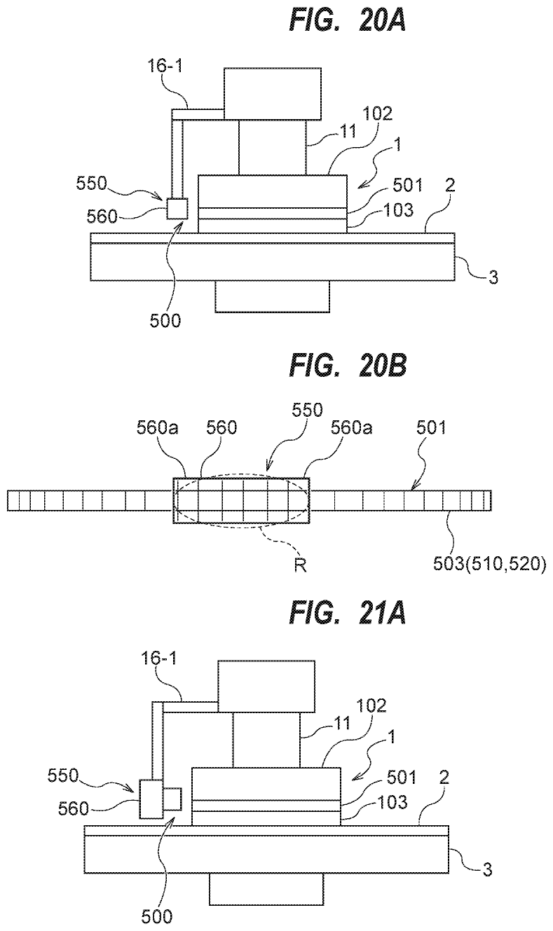

FIG. 20A and FIG. 20B are views showing other embodiments of a detection unit. The detection unit 550 is configured to detect a peripheral edge region R including a contact point position between the wafer W and the retainer ring 103. Specifically, the detection unit 550 includes a light receiving cell 560 extending parallel to the light guide structure 501.

The peripheral edge region R corresponds to an arc-shaped wide space including the contact point position. A width of the light receiving cell 560 has a size equal to or larger than the peripheral edge region R. The light receiving cell 560 is configured to output an electrical signal according to an intensity of reflected light entering from a peripheral edge PP of the wafer W. In one embodiment, the detection unit 550 may have the light receiving cell 560 instead of a photodetector 553. However, the detection unit 550 may have the light receiving cell 560 in addition to the photodetector 553.

In an embodiment shown in FIG. 20B, the light receiving cell 560 has a plurality of cell bodies 560a arranged parallel to the light guide structure 501, but may have a single cell body having a size equal to or larger than the peripheral edge region R.

The light receiving cell 560 is configured to detect reflected light from the light guide structure 501 in the peripheral edge region R. The control device 9 is electrically connected to the light receiving cell 560, and acquires a signal detected by the light receiving cell 560. Thereafter, the control device 9 determines a state change of the wafer W based on a change in the peripheral edge region R over time.

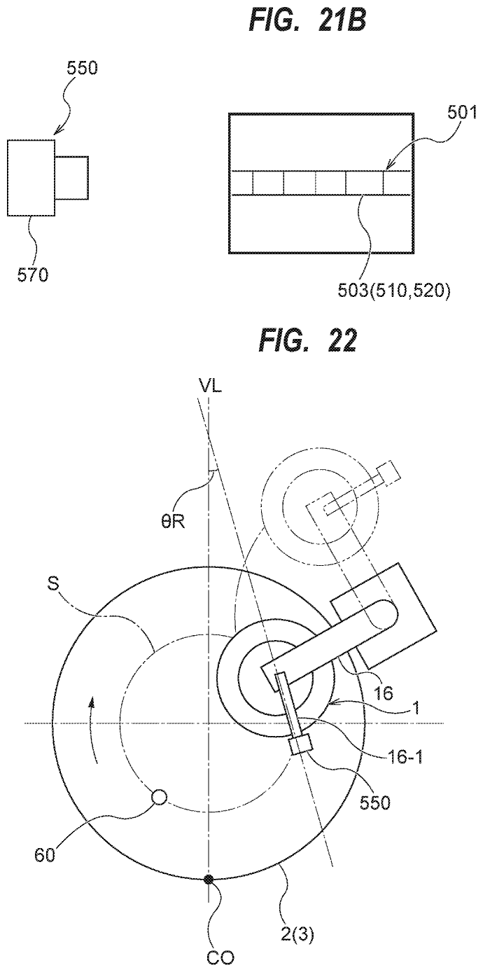

FIG. 21A and FIG. 21B are views showing other embodiments of a detection unit. The detection unit 550 may include an imaging camera 570 that images the peripheral edge region R. The detection unit 550 may have the imaging camera 570 instead of the photodetector 553, and may have the imaging camera 570 in addition to the photodetector 553.

The imaging camera 570 is configured to image reflected light from the light guide structure 501 in the peripheral edge region R. The control device 9 measures a change in a contact point position in the peripheral edge region R based on image data acquired from the imaging camera 570, and determines a state change of the wafer W.

The imaging camera 570 does not necessarily have to be attached to the unit supporter 16-1 as long as it is at a position where it can image the light guide structure 501, and may be arranged on a wall (not shown) housing the polishing apparatus.

As described above, if the notch position NT of the wafer W can be specified, accurate film thickness distribution information (wafer map) can be acquired (created), and uniformity of a film thickness distribution of the wafer W can be improved. Therefore, a configuration for acquiring film thickness distribution information will be described below.

FIG. 22 is a view showing an embodiment of a film thickness sensor. As shown in FIG. 22, the polishing apparatus includes a film thickness sensor 60 embedded in the polishing table 3. The film thickness sensor 60 draws an identical trajectory as the virtual circle S (that is, a rotation trajectory of the polishing surface 2a passing through a center CP of the wafer W) along with rotation of the polishing table 3, and passes under a surface to be polished of the wafer W.

The film thickness sensor 60 is configured to detect a physical quantity depending on a film thickness (specifically, a signal reflecting a film thickness of the wafer W) that changes according to a film thickness of the wafer W. Examples of the film thickness sensor 60 can include an optical sensor or an eddy current sensor.

When the film thickness sensor 60 corresponds to an eddy current sensor, an eddy current sensor is configured such that a sensor coil thereof passes a magnetic flux through a conductive film of the wafer W to generate an eddy current, thereby detecting an eddy current depending on a film thickness of the wafer W and outputting an eddy current signal. The control device 9 determines a film thickness of the wafer W based on an eddy current signal.

When the film thickness sensor 60 corresponds to an optical sensor, the film thickness sensor 60 is configured to shine light on a surface to be polished of the wafer W, receive reflected light from the wafer W, and decompose reflected light according to wavelengths. The control device 9 measures intensities of reflected light at respective wavelengths over a predetermined wavelength range, generates a spectrum representing a light intensity for each wavelength from obtained light intensity data (an optical signal reflecting a film thickness of the wafer W), and determines a film thickness of the wafer W from a spectrum.

The control device 9 measures a film thickness of the wafer W based on a signal detected by the film thickness sensor 60 rotating along with rotation of the polishing table 3. Furthermore, the control device 9 specifies a wafer angle specified by the notch position NT based on a phase of the notch position NT detected by the detection unit 550 and a phase of a signal detected by the film thickness sensor 60. Hereinafter, the wafer angle specified by the notch position NT may be referred to as a notch angle.

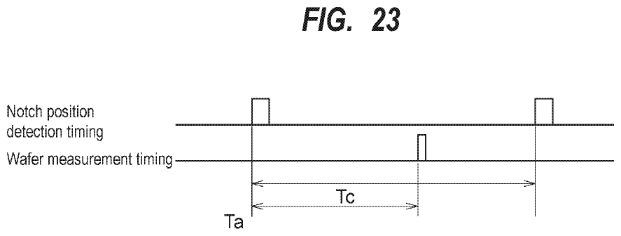

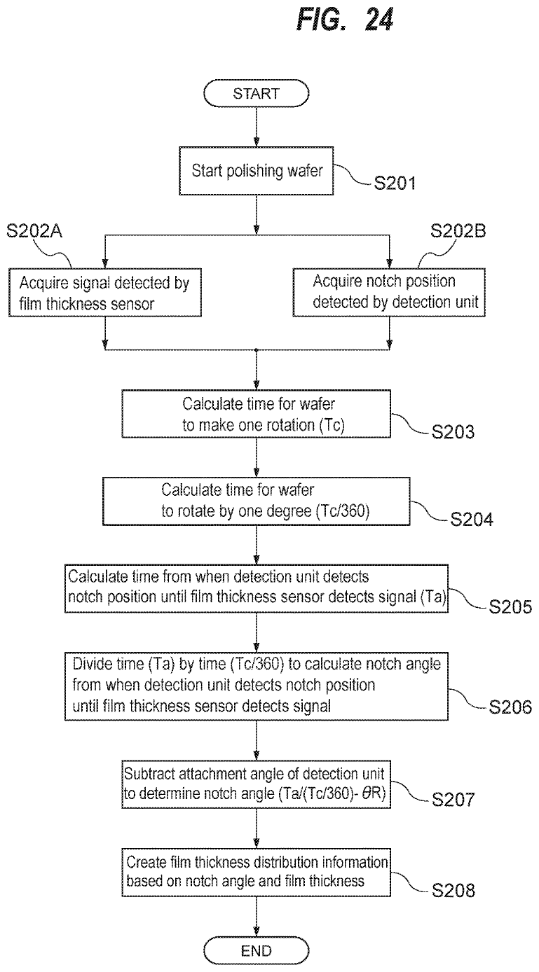

FIG. 23 is a timing chart showing a phase of the notch position detected by the detection device and a phase of a signal detected by the film thickness sensor. FIG. 24 is a view showing a processing flow of the control device for specifying the notch angle. In FIG. 23, an upper timing chart shows the notch position detection timing by the detection unit 550, and a lower timing chart shows a wafer measurement timing by the film thickness sensor.

First, the control device 9 starts polishing the wafer W (see step S201), and acquires a signal detected by the film thickness sensor 60 and the notch position detected by the detection unit 550 (see steps S202A and S202B).

The detection unit 550 periodically detects the notch position NT passing through the peripheral edge region R along with rotation of a polishing head 1. As shown in FIG. 23, a time interval of the notch position NT detected by the detection unit 550 when the wafer W makes one rotation is defined as a time Tc.

In this case, the control device 9 calculates the time Tc (see step S203), and calculates a time for the wafer W to rotate by one degree, that is, a rotation time of the wafer W per unit angle (see step S204). A time for the wafer W to rotate by one degree is calculated by dividing the time Tc by 360 degrees under a condition where the wafer W rotates stably (Tc/360).

Further, as shown in step S205, the control device 9 calculates a time interval (that is, a time Ta) from a time point when the detection unit 550 detects the notch position NT to a time point when the film thickness sensor 60 detects a signal (see FIG. 23).

Thereafter, as shown in step S206, the control device 9 calculates the notch angle from when the detection unit 550 detects the notch position NT to when the film thickness sensor 60 detects a signal by dividing the time Ta by a time for the wafer W to rotate by one degree (Tc/360) (Ta/(Tc/360)).

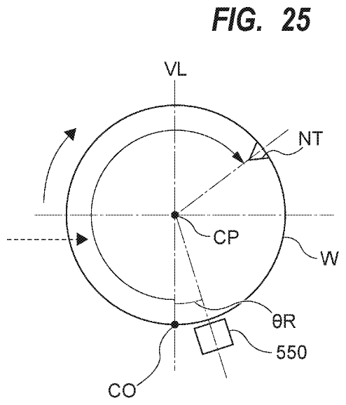

FIG. 25 is a view showing an attachment angle of a detection unit. As shown in FIG. 25, a point on the imaginary line VL is defined as the apparatus angle origin CO. In an embodiment shown in FIG. 25, the detection unit 550 is arranged shifted by an attachment angle θR from the apparatus angle origin CO on the imaginary line VL.

Therefore, the control device 9 determines the notch angle in consideration of the attachment angle θR. Specifically, the control device 9 subtracts the attachment angle θR from the notch angle calculated in step S206 (Ta/(Tc/360)−θR) (see step S207).

In this manner, the control device 9 can determine the notch angle from an apparatus angle origin CO. When the attachment angle θR is zero, that is, when the detection unit 550 is arranged at the apparatus angle origin CO, the control device 9 determines (specifies) the notch angle without subtracting the attachment angle θR.

Thus, the control device 9 can derive the notch angle from the apparatus angle origin CO by calculating the time Ta and the time Tc based on signals acquired from the detection unit 550 and the film thickness sensor 60.

Thereafter, the control device 9 creates film thickness distribution information (wafer map) based on the notch angle by associating a specified notch angle with a film thickness measured based on a signal detected by the film thickness sensor 60 (see step S208).

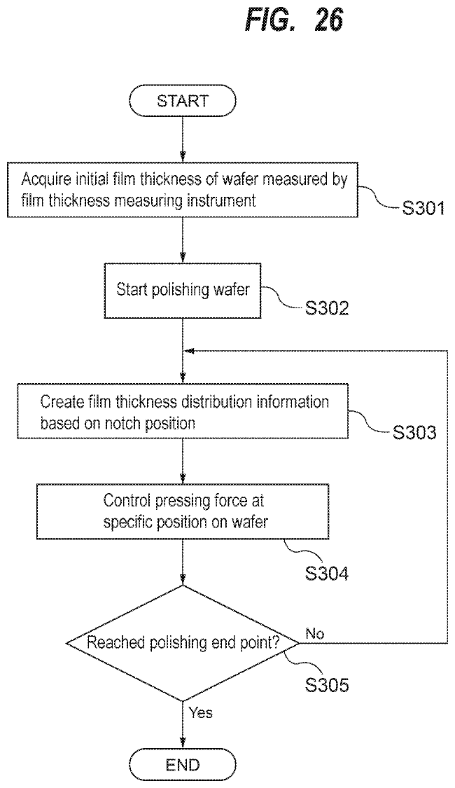

FIG. 26 is a view showing a processing flow of the control device when polishing the wafer. First, a film thickness of the wafer W is measured by a film thickness measuring instrument (not shown) provided in the polishing apparatus or separate from the polishing apparatus. The control device 9 acquires an initial film thickness distribution of the wafer W measured by a film thickness measuring instrument (see step S301).

Thereafter, the control device 9 starts polishing the wafer W (see step S302). After starting polishing of the wafer W, the control device 9 executes step S202 to step S208 of FIG. 24 to create film thickness distribution information based on the notch angle (see step S303). Note that it is desirable to periodically measure and update film thickness distribution information a plurality of times during polishing of the wafer W.

Measuring methods by a film thickness measuring instrument provided in the polishing apparatus are roughly classified into a method of measuring an absolute film thickness of the wafer W (first measuring method) and a method of measuring a polishing amount (second measuring method). In a case of a first measuring method, a film thickness measuring instrument outputs a film thickness value (e.g., thickness=100 nm, etc.) of the wafer W. In a case of a second measuring method, a film thickness measuring instrument outputs a polishing amount (e.g., polishing amount from a certain reference value=50 nm, etc.).

When executing a first measuring method, the control device 9 starts polishing the wafer W and creates film thickness distribution information. Note that step S301 may be omitted, or step S301 may be executed, and an acquired initial film thickness may be compared with film thickness distribution information created at a beginning of polishing to detect a measurement abnormality. When executing a second measuring method, after executing step S301, the control device 9 starts polishing the wafer W. In this case, the control device 9 creates film thickness distribution information by subtracting a polishing amount measured by a film thickness measuring instrument from an initial film thickness of the wafer W measured in step S301 or film thickness distribution information created in advance in step S303.

The control device 9 specifies specific positions (locations where a film thickness is particularly thick or locations where a film thickness is particularly thin) on the wafer W based on film thickness distribution information, and operates a pressure adjustment device 165 based on a rotation angle of the polishing head 1 acquired from the rotary encoder 41 (see FIG. 1) that detects a rotation angle of the polishing head 1. The control device 9 may specify specific positions on the wafer W from an initial film thickness distribution measured by a film thickness measuring instrument (see step S301) without using film thickness distribution information acquired during polishing.

The control device 9 individually controls a pressure of fluid supplied to the pressure chambers 116 by operating the pressure adjustment device 165 to actively polish locations where a film of the wafer W is thick, or actively polish locations other than locations where a film of the wafer W is thin (see step S304).

Thereafter, the control device 9 determines whether a film thickness of the wafer W has reached a polishing end point by measuring a phase shift (change) of the notch position NT. If a phase shift has not occurred, the control device 9 continues polishing of the wafer W (see “No” in step S305). If a phase shift has occurred, the control device 9 finishes polishing of the wafer W (see “Yes” in step S305).

In order to further improve uniformity of film thickness, after polishing of the wafer W in the polishing apparatus is completed, the wafer W may be transferred to a film thickness measuring instrument (not shown) to create film thickness distribution information of the wafer W, and then the wafer W may be transferred to a finishing polishing apparatus (e.g., face-up type polishing apparatus) different from the above polishing apparatus to additionally polish the wafer W. However, in such a method, a number of times the wafer W is transferred increases.

According to the present embodiment, since the control device 9 creates film thickness distribution information during polishing of the wafer W, after polishing of the wafer W is completed, the wafer W can be transferred to a finishing polishing apparatus without transferring the wafer W to a film thickness measuring instrument. Therefore, a number of times the wafer W is transferred can be reduced, and as a result, throughput of the wafer W can be improved.

The above-described embodiments have been described for the purpose of enabling a person having ordinary knowledge in the technical field to which the present invention belongs to carry out the present invention. Various modifications to the above embodiments can be naturally made by those skilled in the art, and the technical idea of the present invention can be applied to other embodiments. Therefore, the present invention is not limited to the described embodiments, but is intended to be interpreted in the broadest scope in accordance with the technical idea defined by the claims.

What is claimed is:

1. A polishing apparatus comprising:
a polishing table configured to support a polishing pad;
a polishing head configured to hold a substrate with an exposed surface of the substrate facing a polishing surface of the polishing pad;
a detection device configured to detect a reference position of the substrate; and
a control device electrically connected to the detection device,
wherein the detection device is configured to periodically detect the reference position rotating together with the polishing head, and
wherein the control device is configured to determine a state change of the substrate based on the reference position periodically detected by the detection device.

2. The polishing apparatus according to claim 1,
wherein the reference position corresponds to a notch position formed at a peripheral edge of the substrate,
wherein the detection device is configured to:
project light from outside the substrate toward the peripheral edge of the substrate, and
detect reflected light reflected at the peripheral edge of the substrate, and
wherein the control device is configured to determine the notch position based on an intensity of the reflected light detected by the detection device.

3. The polishing apparatus according to claim 1,
wherein the substrate has a structure including a plurality of materials having different friction coefficients, and
wherein the control device is configured to determine a polishing end point as the state change based on a change in a friction coefficient between the substrate and the polishing pad caused by a surface structure of the substrate that changes with progress of polishing.

4. The polishing apparatus according to claim 1,
wherein the control device is configured to measure a phase of the reference position, and determine a polishing abnormality of the substrate based on a magnitude of a change in the phase when the state change is determined.

5. The polishing apparatus according to claim 4,
wherein when constituent elements of the polishing apparatus including at least the polishing pad, the polishing table, and the polishing head are defined as polishing components, and
wherein the control device is configured to determine an occurrence of at least one of an abnormality of the substrate itself and an abnormality of the polishing components as the polishing abnormality.

6. The polishing apparatus according to claim 1,
wherein the control device is configured to determine a change in polishing conditions of the substrate as the state change based on a change in a friction coefficient between the substrate and the polishing pad.

7. The polishing apparatus according to claim 1,
wherein the polishing apparatus comprises a film thickness sensor embedded in the polishing table,
wherein the film thickness sensor is configured to periodically detect a signal reflecting a film thickness of the substrate along with rotation of the polishing table, and
wherein the control device is configured to:
measure the film thickness of the substrate based on the signal detected by the film thickness sensor;
specify a substrate angle as an angle in a circumferential direction of the substrate specified by the reference position based on a phase of the reference position detected by the detection device and a phase of the signal detected by the film thickness sensor; and
create film thickness distribution information of the substrate based on the specified substrate angle and the measured film thickness of the substrate.

8. The polishing apparatus according to claim 7,
wherein the control device is configured to:
calculate a rotation time of the substrate per unit angle from a time interval of the reference position detected by the detection device; and
specify the substrate angle based on the rotation time of the substrate and a time interval from a time point when the detection device detects the reference position to a time point when the film thickness sensor detects the signal.
